(19) United States
(12) Patent Application Publication
(10) Pub. No.: US 2026/0192414 A1
(43) Pub. Date: Jul. 9, 2026

(54) CUTTING PARAMETER ADJUSTMENT BASED ON COATING HEALTH ASSESSMENT OF CUTTING TOOLS

(71) Applicant: International Business Machines Corporation, Armonk, NY (US)

(72) Inventors: Sarbajit Kumar Rakshit, Kolkata (IN); Sathya Santhar, Ramapuram (IN); Sridevi Kannan, Katupakkam (IN)

(21) Appl. No.: 19/010,267

(22) Filed: Jan. 6, 2025

(51) Int. Cl. B23Q 17/09; G05B 13/02; G05B 13/04

(52) U.S. Cl. CPC B23Q 17/0995; B23Q 17/0952; G05B 13/0265; G05B 13/04

(57) ABSTRACT

Examples described herein provide for selecting and configuring cutting tools based on simulated damage analysis. Aspects include identifying a cutting operation to be performed by a machining device on a workpiece, identifying a plurality of cutting tools of the machining device that are suitable for performing the cutting operation, and simulating the cutting operation being performed with each of the plurality of cutting tools. Aspects also include analyzing simulated damage to each of the plurality of cutting tools due to performance of the cutting operation and selecting one of the plurality of cutting tools to perform the cutting operation based on the simulated damage to each of the plurality of cutting tools. Aspects further include configuring the machining device to perform the cutting operation using the selected cutting tool and performing the cutting operation using the selected cutting tool.

### BACKGROUND

The discourse relates generally to manufacturing technologies and more specifically to cutting parameter adjustment based on a coating health assessment of cutting tools.

In machining operations, surface treatments play a role in enhancing tool life and performance. Surface treatments provide a thermal barrier between the cutting edge and the workpiece, increase the hardness on the surface of the tool, and improve lubricity for better chip flow and evacuation. These properties help in minimizing built-up edge, improving surface finish, and reducing abrasive wear.

Determining the optimal surface treatment thickness presents a significant challenge. Excessive thickness can lead to issues such as increased heat generation and poor surface finish. Conversely, insufficient thickness can result in reduced productivity and increased wear and tear of the tool. Traditional methods lack precision in assessing surface treatment condition and making necessary adjustments, leading to suboptimal performance and reduced tool life.

### SUMMARY

According to one aspect of the present invention, a computer-implemented method for selecting and configuring cutting tools based on simulated damage analysis is provided. The computer-implemented method includes identifying a cutting operation to be performed by a machining device on a workpiece, identifying a plurality of cutting tools of the machining device that are suitable for performing the cutting operation, and simulating the cutting operation being performed with each of the plurality of cutting tools. The computer-implemented method also includes analyzing simulated damage to each of the plurality of cutting tools due to performance of the cutting operation and selecting one of the plurality of cutting tools to perform the cutting operation based on the simulated damage to each of the plurality of cutting tools. The computer-implemented method further includes configuring the machining device to perform the cutting operation using the selected cutting tool and performing the cutting operation using the selected cutting tool.

According to another aspect of the present invention, a system for selecting and configuring cutting tools based on simulated damage analysis is provided. The system includes a memory comprising computer-readable instructions and a processing device for executing the computer-readable instructions. The computer-readable instructions control the processing device to perform operations including identifying a cutting operation to be performed by a machining device on a workpiece, identifying a plurality of cutting tools of the machining device that are suitable for performing the cutting operation, and simulating the cutting operation being performed with each of the plurality of cutting tools. The operations also include analyzing simulated damage to each of the plurality of cutting tools due to performance of the cutting operation and selecting one of the plurality of cutting tools to perform the cutting operation based on the simulated damage to each of the plurality of cutting tools. The operations further include configuring the machining device to perform the cutting operation using the selected cutting tool and performing the cutting operation using the selected cutting tool.

According to yet another aspect of the present invention, a computer program product for selecting and configuring cutting tools based on simulated damage analysis is provided. The computer program product comprises a set of one or more computer-readable storage media and program instructions collectively stored in the set of one or more storage media. The program instructions cause a processor set to perform operations including identifying a cutting operation to be performed by a machining device on a workpiece, identifying a plurality of cutting tools of the machining device that are suitable for performing the cutting operation, and simulating the cutting operation being performed with each of the plurality of cutting tools. The operations also include analyzing simulated damage to each of the plurality of cutting tools due to performance of the cutting operation and selecting one of the plurality of cutting tools to perform the cutting operation based on the simulated damage to each of the plurality of cutting tools. The operations further include configuring the machining device to perform the cutting operation using the selected cutting tool and performing the cutting operation using the selected cutting tool.

The above features and advantages, and other features and advantages, of the disclosure are readily apparent from the following detailed description when taken in connection with the accompanying drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of one or more embodiments described herein are apparent from the following detailed description taken in conjunction with the accompanying drawings in which:

FIG. 1 illustrates a block diagram of a computing environment, according to one or more embodiments.

FIG. 2 illustrates a block diagram of a system for cutting parameter adjustment based on a coating health assessment of cutting tools according to one or more embodiments.

FIG. 3 illustrates a flow chart diagram of a method for selecting and configuring cutting tools based on simulated damage analysis according to one or more embodiments.

FIG. 4 illustrates a flow chart diagram of a method for cutting parameter adjustment based on a coating health assessment of cutting tools according to one or more embodiments.

FIG. 5 illustrates a flow chart diagram of a method for simulating a cutting operation being performed with a cutting tool according to one or more embodiments.

The detailed description explains embodiments of the disclosure, together with advantages and features, by way of example with reference to the drawings.

### DETAILED DESCRIPTION

In metal cutting operations, cutting tool coatings play a role in enhancing tool life and performance. Coatings provide a thermal barrier between the cutting edge and the workpiece, increase the hardness on the surface of the tool, and improve lubricity for better chip flow and evacuation. These properties help in minimizing built-up edge, improving surface finish, and reducing abrasive wear. Determining the optimal coating thickness presents a significant challenge. Excessive coating thickness can lead to issues such as increased heat generation and poor surface finish. Insufficient thickness can result in reduced productivity and increased wear and tear of the tool.

Traditional methods for assessing the condition of cutting tool coatings and making necessary adjustments lack precision. These methods often fail to accurately determine the optimal coating thickness, leading to suboptimal performance and reduced tool life. Additionally, conventional approaches do not adequately account for the dynamic nature of machining operations, where real-time adjustments to cutting parameters are crucial for maintaining coating health and ensuring consistent productivity. As a result, there is a need for a more advanced system that can dynamically adjust cutting parameters based on real-time assessments of coating health.

The present disclosure addresses the challenge of optimizing cutting tool coatings in metal cutting operations. The system and method described herein utilize an AI-enabled CNC machine to perform trial and error simulations with various combinations of cutting parameters, material properties, and applied energy on different portions of the cutting tool surface. Based on these simulations, the CNC machine selects the appropriate cutting tool for machining specific materials. The system dynamically configures cutting parameters based on real-time microstructure evaluation of the tool's coating, ensuring optimal performance and extended tool life. Additionally, the system activates secondary systems, such as selectively applying coolant or lubricant, to prevent damage to the cutting tool coating and the associated workpiece.

Descriptions of various embodiments of the present disclosure are presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Various aspects of the present disclosure are described by narrative text, flowcharts, block diagrams of computer systems, and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random-access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

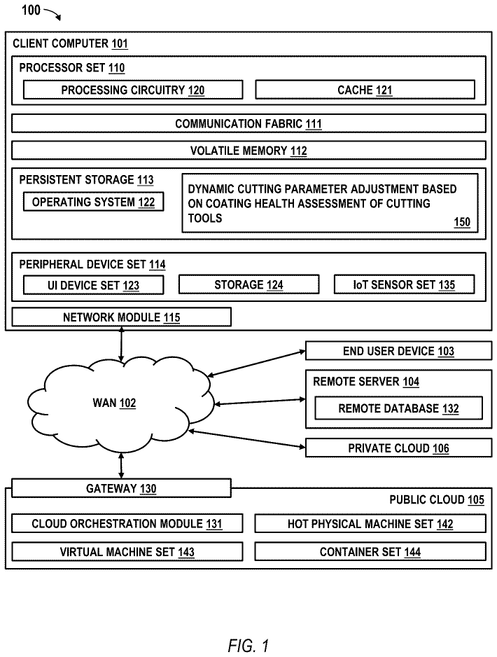

FIG. 1 illustrates a computing environment 100, according to an embodiment. Computing environment 100 contains an example of an environment for the execution of at least some of the computer code involved in cutting parameter adjustment based on coating health assessment of cutting tools, as shown at block 150. In addition to a controller for controlling the operations of a metal cutting tool, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input / output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface-type operating systems that employ a kernel. The code included in persistent storage 113 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

According to one or more embodiments, the computing environment 100 can provide for remote data storage. For example, the computer 101 can be a cloud storage system or other suitable system for storing data that is accessible to a user remotely, such as by accessing the computer 101 using the end user device 103. That is, a user can send a user operation (also referred to as a “user request”) from the end user device 103 to the computer 101 via the WAN 102. Although the user operation may appear to be simple, such as uploading an object to a cloud storage system, the complications of operating a cloud computing system often have side effects and produce ancillary data, which may be consumed by both the operator of the system (e.g., the computer 101) and by users or other components of the cloud architecture (e.g., the computing environment 100). Ancillary data may be created by user operations that trigger the creation of the ancillary data. Ancillary data may be resource consumption information, notification data, and/or the like, including combinations and/or multiples thereof. Data for an independent event may be inferred from another event (e.g., event to update resource consumption information for an entity in a system also means that the total consumption information for the owner of the entity is also updated).

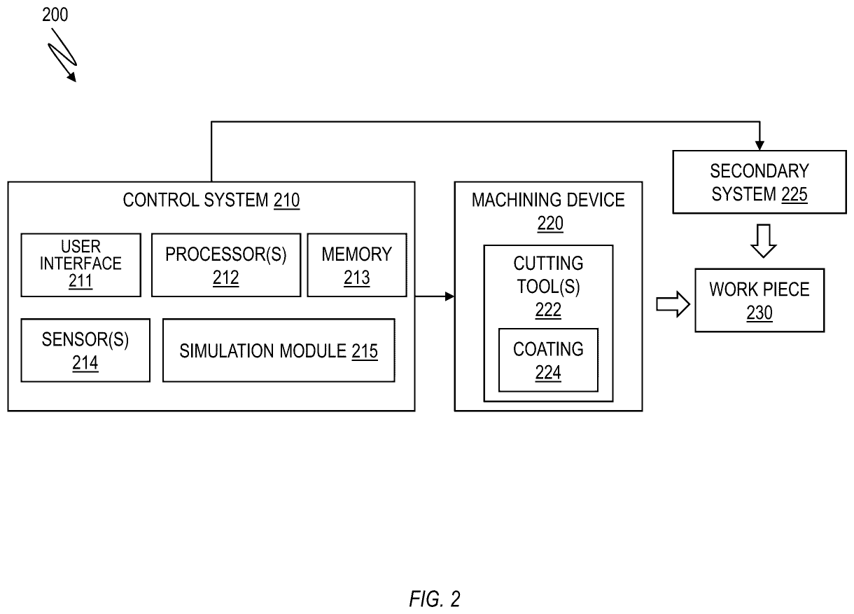

Referring now to FIG. 2, a block diagram of a system 200 for cutting parameter adjustment based on coating health assessment of cutting is shown. The system 200 includes a control system 210, which serves as the central unit for managing and coordinating the various components involved in the cutting parameter adjustment process. The control system 210 interfaces with multiple subsystems to ensure optimal performance and tool longevity during machining operations.

In exemplary embodiments, the user interface 211 connects to the control system 210, allowing operators to input data, monitor system status, and adjust settings as needed. The user interface 211 can be implemented using various devices such as touchscreens, keyboards, and display monitors. The user interface 211 interface provides real-time feedback and control options, enabling operators to make informed decisions based on the system's assessments and recommendations.

In exemplary embodiments, the processor(s) 212 within the control system 210 execute the computational tasks required for the system's operation. These processors handle data processing, algorithm execution, and communication between different components. The processor(s) 212 can be implemented using multi-CPU, GPUs, or specialized AI processors, depending on the computational demands of the system. The processors 212 ensure that the system can perform real-time assessments and adjustments to the cutting parameters based on the coating health of the cutting tools.

In exemplary embodiments, the memory 213 stores the data and instructions necessary for the system's operation. This includes historical data on tool coating specifications, cutting parameters, and machining outcomes, as well as the algorithms used for simulations and assessments. The memory 213 can be implemented using various types of storage, such as ram, rom, and solid-state drives (SSDS). The memory ensures that the system has quick access to the necessary data and instructions for real-time processing and decision-making.

In exemplary embodiments, the sensor(s) 214 are connected to the control system 210 and are responsible for collecting real-time data during the machining process. These sensors can include thermal cameras, vibration sensors, and microstructure imaging devices. The sensor(s) 214 monitor various parameters such as temperature, vibration levels, and the condition of the cutting tool 222 and the workpiece 230. The data collected by the sensors 214 is used by the control system 200 to assess the health of a coating of the cutting tool and make necessary adjustments to the cutting parameters of the cutting tool.

In one embodiment, the sensors 214 are used for real-time assessments of the tool coating health during the cutting operation include high-resolution thermal cameras that capture detailed thermal images of the cutting tool and workpiece. These thermal cameras can detect minute temperature variations, allowing the system to identify hotspots and areas of potential overheating that could damage the tool coating. In another embodiment, advanced vibration sensors are employed to monitor the vibration levels of the cutting tool and the machining device. These sensors can detect subtle changes in vibration patterns that may indicate wear or defects in the tool coating, enabling the system to make timely adjustments to the cutting parameters. Additionally, in a further embodiment, the system integrates both thermal cameras and vibration sensors to provide a comprehensive assessment of the tool coating health. This dual-sensor approach allows the system to cross-reference data from both thermal and vibration analyses, ensuring more accurate and reliable real-time assessments. The integration of these sensors into the control system enhances the system's ability to dynamically adjust cutting parameters, thereby optimizing tool performance and extending tool life.

In exemplary embodiments, the simulation module 215 within the control system 210 performs simulations to determine the optimal cutting parameters for specific machining operations. The simulation module 215 uses historical data and real-time sensor inputs to simulate various combinations of cutting speed, feed rate, depth of cut, and other parameters. The results of these simulations help the system select the appropriate cutting tool and configure the cutting parameters to ensure optimal performance and tool longevity.

In exemplary embodiments, the machining device 220 is the physical apparatus that performs the cutting operations on the workpiece 230. The machining device 220 includes various components such as spindles, tool holders, and cutting tools 222. The control system 210 communicates with the machining device 220 to dynamically adjust the cutting parameters based on the real-time assessments of the tool coating health. This ensures that the machining process is optimized for both productivity and tool longevity.

In exemplary embodiments, the cutting tool(s) 222 are the tools used by the machining device 220 to perform the cutting operations. These tools are coated with materials that enhance their performance and durability. The system assesses the health of the coating on the cutting tool(s) 222 and adjusts the cutting parameters accordingly. The selection of the appropriate cutting tool and the configuration of the cutting parameters are based on the simulations and real-time assessments performed by the system.

In exemplary embodiments, the coating 224 on the cutting tool(s) 222 plays a role in enhancing tool life and performance. The control system 210 evaluates the microstructure of the coating 224, using data from the sensors 214, to identify wear, defects, and other issues that may affect the tool's performance. Based on this evaluation, the control system 210 dynamically adjusts the cutting parameters to prevent further damage to the coating 224 and ensure consistent productivity.

In exemplary embodiments, the secondary system 225 is controlled by the control system 210 to provide additional support during the machining process. This can include selectively applying coolant or lubricant to the cutting tool 222 and workpiece 230 to reduce heat generation and friction. The secondary system 225 helps to maintain the health of the tool coating 224 and improve the overall efficiency of the machining process.

In exemplary embodiments, the secondary system 225 is activated by the control system 210 to provide additional support during the machining process. Examples of the secondary system 225 include a coolant application system, which selectively applies coolant to the cutting tool and workpiece to reduce heat generation and maintain optimal cutting temperatures. The coolant helps to prevent overheating, which can damage the tool coating and affect the quality of the machined workpiece. Additionally, a lubricant application system applies lubricants to the cutting tool and workpiece to reduce friction and improve chip flow, minimizing wear on the tool coating and enhancing the overall efficiency of the machining process.

Another example is the vibration damping system, which uses vibration sensors and actuators to detect and counteract vibrations during the machining process. By reducing vibrations, the system helps to prevent damage to the tool coating and ensures a smoother cutting operation. An air blowing system uses compressed air to blow away chips and debris from the cutting zone, keeping the cutting area clean and maintaining the health of the tool coating while preventing chip buildup that can affect cutting performance.

The thermal monitoring system uses thermal cameras and sensors to monitor the temperature of the cutting tool and workpiece in real-time. Based on the temperature data, the system can adjust the cutting parameters or activate cooling mechanisms to prevent overheating and protect the tool coating. The microstructure imaging system continuously monitors the microstructure of the tool coating during the machining process using imaging devices. By detecting wear, cracks, and other defects in real-time, the system can make necessary adjustments to the cutting parameters to prevent further damage to the coating.

The adaptive control system dynamically adjusts the cutting parameters based on real-time assessments of the tool coating health and machining conditions. By continuously optimizing the cutting parameters, the system ensures sustained productivity and prolongs the life of the cutting tool. Lastly, the chip evacuation system uses mechanical or pneumatic means to evacuate chips from the cutting zone, ensuring efficient chip removal and maintaining the health of the tool coating while preventing chip-related issues that can affect the machining process.

The workpiece 230 is the material being machined by the machining device 220. The system assesses the properties of the workpiece 230, such as material type and hardness, to determine the optimal cutting parameters. The real-time assessments and adjustments made by the system ensure that the machining process is optimized for both the workpiece and the cutting tool.

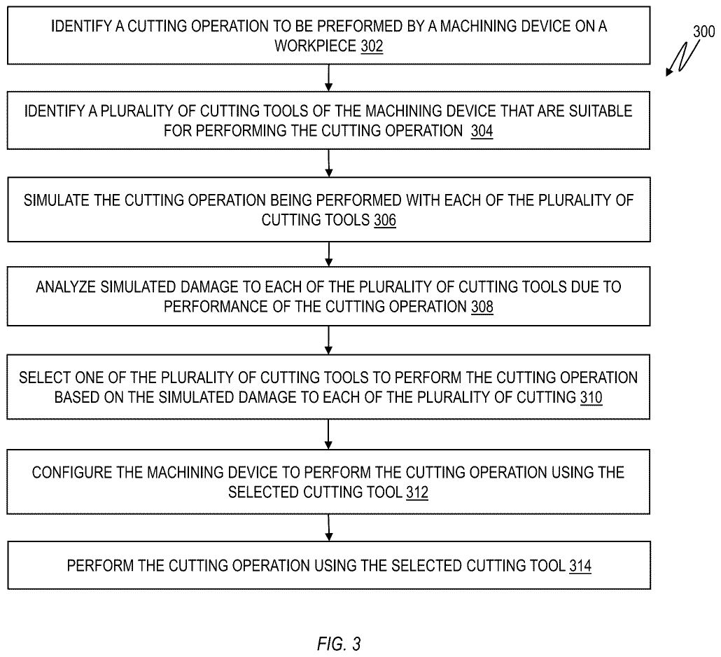

Referring now to FIG. 3, a flow chart diagram of a method 300 for selecting and configuring cutting tools based on simulated damage analysis according to one or more embodiments is shown. The method 300 can be implemented by a control system 210, as shown in FIG. 2. The method 300 begins with identifying a cutting operation to be performed by a machining device on a workpiece, as shown at block 302. The control system 210 analyzes the requirements of the machining operation, including the type of material, desired surface finish, and specific machining tasks such as drilling, turning, or milling. This analysis helps in determining the appropriate cutting tools and parameters needed for the operation.

Next, the method 300 involves identifying a plurality of cutting tools of the machining device that are suitable for performing the cutting operation, as shown at block 304. In exemplary embodiments, the control system 210 scans the available cutting tools, considering their specifications, such as coating type, thickness, and material composition. The control system 210 evaluates the suitability of each tool based on the requirements of the cutting operation and the properties of the workpiece.

The method 300 then proceeds to simulate the cutting operation being performed with each of the plurality of cutting tools, as shown at block 306. In exemplary embodiments, the simulation module 215 within the control system 210 performs these simulations using historical data and real-time sensor inputs. The simulations consider various combinations of cutting parameters, such as cutting speed, feed rate, and depth of cut, to predict the performance and potential damage to each cutting tool during the operation.

In exemplary embodiments, the simulations of the cutting operation being performed with each of the plurality of cutting tools are carried out using a trained artificial intelligence (AI) model. This process involves several detailed steps to ensure accurate and reliable simulation results, which are crucial for selecting the optimal cutting tool and configuring the cutting parameters.

Initially, the AI model is trained using a comprehensive dataset that includes historical data on tool coating specifications, cutting parameters, machining outcomes, and real-time sensor inputs. This dataset encompasses various combinations of cutting speed, feed rate, depth of cut, material properties, and applied energy on different portions of the cutting tool surface. The training process involves using machine learning algorithms, such as regression models, clustering models, or neural networks, to build relationships between coating specifications and metal cutting performance. The AI model learns to predict the impact of different cutting parameters on the tool's performance and coating health.

Once the AI model is trained, it is integrated into the control system 210, where it performs simulations of the cutting operation for each of the plurality of cutting tools. The simulation process begins with the control system 210 inputting the specific requirements of the machining operation, including the type of material, desired surface finish, and specific machining tasks such as drilling, turning, or milling. The AI model then uses this input data, along with the historical data and real-time sensor inputs, to simulate the cutting operation.

During the simulation, the AI model evaluates various combinations of cutting parameters, such as cutting speed, feed rate, and depth of cut, for each cutting tool. It predicts the performance of each tool by analyzing factors such as wear, defects, and changes in the microstructure of the tool coatings. The AI model also considers the influencing factors that can damage the coating during metal cutting operations, such as thermal stress, mechanical stress, and chemical reactions. By estimating the magnitude of energy applied to the tool's coating surface, the AI model can predict the endurance limit and peak energy that can damage the coating.

The AI model performs these simulations iteratively, adjusting the cutting parameters and evaluating the resulting performance and potential damage to each cutting tool. The simulation results are then analyzed by the control system 210, which focuses on identifying the cutting tools that demonstrate optimal performance and minimal damage. This analysis helps in selecting the most suitable cutting tool for the specific machining operation.

Following the simulations, the method 300 involves analyzing the simulated damage to each of the plurality of cutting tools due to the performance of the cutting operation, as shown at block 308. The control system 210 evaluates the results of the simulations, focusing on factors such as wear, defects, and changes in the microstructure of the tool coatings. This analysis helps in identifying the cutting tools that are most likely to withstand the operation without significant damage.

Based on the analysis, the method 300 selects one of the plurality of cutting tools to perform the cutting operation, as shown at block 310. The control system 210 chooses the cutting tool that demonstrates performance and minimal damage in the simulations. This selection ensures that the chosen tool will provide optimal results while maintaining the coating health and longevity of the tool.

Once the appropriate cutting tool is selected, the method 300 involves configuring the machining device to perform the cutting operation using the selected cutting tool, as shown at block 312. The control system 210 selects the cutting parameters, such as cutting speed, feed rate, and depth of cut, based on the real-time assessments and simulation results. This configuration ensures that the machining process is optimized for both productivity and tool longevity.

The method 300 concludes with performing the cutting operation using the selected cutting tool, as shown at block 314. The machining device 220, under the control of the control system 210, executes the cutting operation on the workpiece 230. The control system 210 continuously monitors the performance and health of the cutting tool coating during the operation, making real-time adjustments to the cutting parameters as needed to prevent damage and ensure consistent productivity.

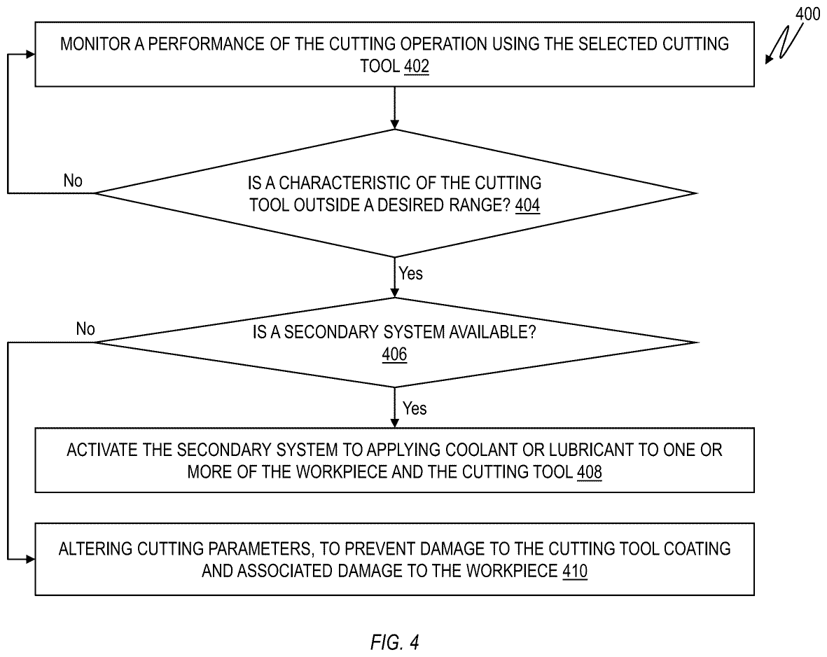

Referring now to FIG. 4, a flow chart diagram of a method 400 for cutting parameter adjustment based on a coating health assessment of cutting tools according to one or more embodiments is shown. The method 400 can be implemented by a control system 210, as shown in FIG. 2. The method 400 begins with monitoring the performance of the cutting operation using the selected cutting tool, as shown at block 402. The control system 210 continuously collects data from various sensors 214 during the machining process. These sensors monitor parameters such as temperature, vibration levels, and the condition of the cutting tool 222 and the workpiece 230. The collected data is used to assess the health of the coating on the cutting tool and to make necessary adjustments to the cutting parameters.

Next, the method 400 involves determining whether a characteristic of the cutting tool is outside a desired range, as shown at decision block 404. The control system 210 analyzes the data collected from the sensors 214 to identify any deviations from the optimal performance range. Characteristics such as temperature, vibration, and wear are evaluated to determine if they fall outside the predefined acceptable limits. If any characteristic is found to be outside the desired range, the control system 210 proceeds to the next step.

The method 400 then checks if a secondary system is available, as shown at decision block 406. The control system 210 evaluates the availability of secondary systems 225 that can provide additional support during the machining process. These secondary systems may include coolant application systems, lubricant application systems, vibration damping systems, air blowing systems, thermal monitoring systems, microstructure imaging systems, adaptive control systems, and chip evacuation systems.

Based on a determination that a secondary system is available, the method 400 involves activating the secondary system to apply coolant or lubricant to one or more of the workpiece and the cutting tool, as shown at block 408. The control system 210 selectively applies coolant or lubricant to reduce heat generation and friction, thereby maintaining the health of the tool coating and improving the overall efficiency of the machining process. The coolant helps to prevent overheating, which can damage the tool coating and affect the quality of the machined workpiece. The lubricant reduces friction and improves chip flow, minimizing wear on the tool coating and enhancing the overall efficiency of the machining process.

Based on a determination that a secondary system is not available or if additional adjustments are needed, the method 400 involves altering the cutting parameters to prevent damage to the cutting tool coating and associated damage to the workpiece, as shown at block 410. The control system 210 dynamically adjusts the cutting parameters, such as cutting speed, feed rate, and depth of cut, based on the real-time assessments of the tool coating health. By continuously optimizing the cutting parameters, the system ensures sustained productivity and prolongs the life of the cutting tool. The adjustments help to prevent further damage to the coating and ensure consistent productivity during the machining process.

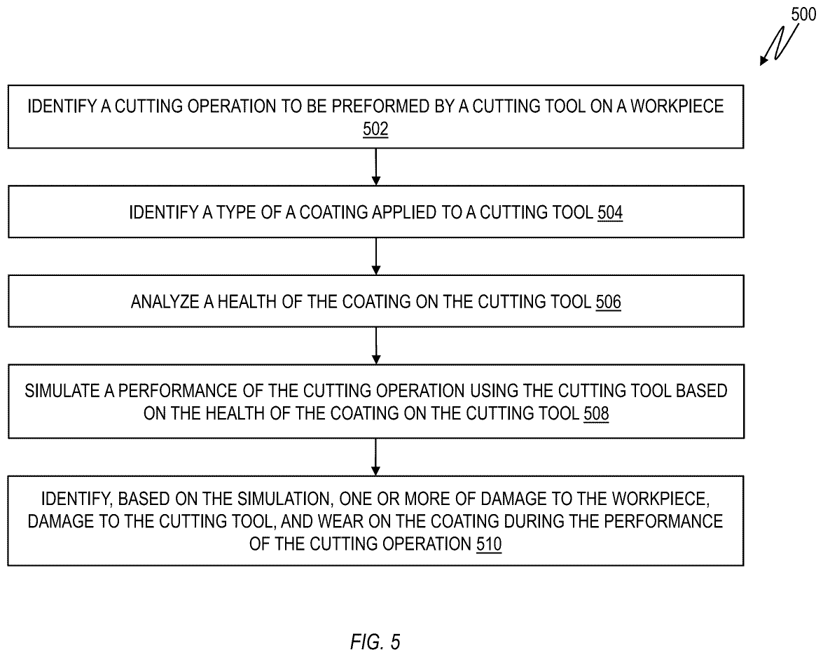

Referring now to FIG. 5, a flow chart diagram of a method 500 for simulating a cutting operation being performed with a cutting tool according to one or more embodiments is shown. The method 500 can be implemented by a control system 210, as shown in FIG. 2. The method 500 begins with identifying a cutting operation to be performed by a cutting tool on a workpiece, as shown at block 502. The control system 210 analyzes the requirements of the machining operation, including the type of material, desired surface finish, and specific machining tasks such as drilling, turning, or milling. This analysis helps in determining the appropriate cutting tools and parameters needed for the operation.

Next, the method 500 involves identifying a type of a coating applied to a cutting tool, as shown at block 504. The control system 210 evaluates the specifications of the cutting tool, including the type, thickness, and material composition of the coating. This evaluation helps in understanding the performance characteristics and durability of the cutting tool during the machining operation.

The method 500 also includes analyzing a health of the coating on the cutting tool, as shown at block 506. The control system 210 uses data from sensors 214, such as thermal cameras and microstructure imaging devices, to assess the condition of the coating. This analysis includes identifying wear, defects, and other issues that may affect the tool's performance. The real-time assessment of the coating health ensures that the cutting parameters can be adjusted dynamically to prevent further damage and maintain consistent productivity.

Following the analysis, the method 500 involves simulating a performance of the cutting operation using the cutting tool based on the health of the coating on the cutting tool, as shown at block 508. The simulation module 215 within the control system 210 performs these simulations using historical data and real-time sensor inputs. The simulations consider various combinations of cutting parameters, such as cutting speed, feed rate, and depth of cut, to predict the performance and potential damage to the cutting tool during the operation. The results of these simulations help the system select the appropriate cutting tool and configure the cutting parameters to ensure optimal performance and tool longevity.

Next, the method 500 involves identifying, based on the simulation, one or more of damage to the workpiece, damage to the cutting tool, and wear on the coating during the performance of the cutting operation, as shown at block 510. The control system 210 evaluates the results of the simulations, focusing on factors such as wear, defects, and changes in the microstructure of the tool coatings. This analysis helps in identifying the cutting tools that are most likely to withstand the operation without significant damage. The control system 210 then uses this information to make necessary adjustments to the cutting parameters or to select a different cutting tool if required.

In exemplary embodiments, the system includes a detailed method for historically gathering tool coating specifications, metal cutting quality, heat generation, and correlating these with various coating parameters along with metal cutting parameters. This historical data gathering process is essential for building a comprehensive dataset that can be used to optimize cutting parameters and enhance tool performance. Initially, the system gathers historical data on tool coating specifications, including coating thickness, type of coating material, and other relevant details. This information can be obtained from tool manufacturers, specifications mentioned in the tool documentation, and previous machining operations. The system stores this data in a centralized database for easy access and analysis.

During metal cutting operations, the system continuously collects data on metal cutting parameters, such as cutting speed, feed rate, depth of cut, workpiece material type, and hardness. This data is recorded in real-time and stored in the database for future reference. The system also tracks the formation pattern of the chips, such as continuous chips, chipping, and other chip formation characteristics. This information is crucial for understanding the cutting process and optimizing cutting parameters. To capture heat generation at the cutting zone, the system uses thermal cameras. These cameras detect and record the temperature variations during the cutting process, providing valuable insights into the thermal behavior of the cutting tool and workpiece. The thermal data is stored in the database and correlated with other cutting parameters to identify patterns and optimize cutting conditions.

The system also monitors the health condition of the coating through microstructure imaging. High-resolution imaging devices capture detailed images of the coating's microstructure, allowing the system to detect wear, tear, microcracks, and other defects. This data is recorded and analyzed to assess the coating's condition and predict its remaining useful life. The microstructure data is correlated with other cutting parameters to identify the factors that influence coating health and performance.

Additionally, the system tracks metal cutting quality, such as surface finish, dimensional accuracy, and the microstructure of the final product. This information is essential for evaluating the effectiveness of the cutting process and making necessary adjustments to improve quality. The system stores this data in the database and uses it to build relationships between coating specifications, cutting parameters, and cutting quality. By gathering and correlating historical data on tool coating specifications, metal cutting parameters, heat generation, chip formation patterns, and cutting quality, the system creates a comprehensive dataset that can be used to optimize cutting parameters and enhance tool performance. This detailed historical data gathering process enables the system to make informed decisions, improve cutting efficiency, and extend the life of cutting tools.

In exemplary embodiments, the system includes a method for predicting when the coating on a cutting tool may be damaged, allowing for proactive action to be taken to ensure continuous and efficient machining operations. This proactive approach helps in maintaining optimal tool performance and minimizing downtime due to unexpected tool failures. Initially, the system continuously monitors the health condition of the coating on the cutting tool using various sensors and imaging devices. These sensors collect real-time data on parameters such as temperature, vibration levels, and the microstructure of the coating. The data is analyzed to detect signs of wear, tear, microcracks, and other defects that may indicate potential damage to the coating.

Based on the real-time assessments and historical data, the system uses predictive algorithms to estimate the remaining useful life of the coating. The predictive algorithms consider factors such as the rate of wear, the severity of detected defects, and the operating conditions of the cutting tool. By analyzing these factors, the system can predict when the coating is likely to reach its endurance limit and become damaged. When the system predicts that the coating may be damaged within a certain timeframe, it triggers proactive actions to ensure continuous machining operations. One such action is making replacement tools available. The system can alert operators to prepare replacement cutting tools with the required coating specifications, ensuring that a new tool is ready for use when the current tool reaches its end of life.

Another proactive action involves correcting the coating by the CNC machine. If the system detects that only certain portions of the coating are damaged, it can initiate corrective measures to restore the coating's integrity. This may include selectively applying additional coating material to the affected areas or adjusting the cutting parameters to reduce further damage and extend the tool's life. Additionally, the system can dynamically adjust the cutting parameters based on the predicted coating damage. By altering parameters such as cutting speed, feed rate, and depth of cut, the system can minimize the stress on the coating and prevent further deterioration. This dynamic adjustment helps in maintaining consistent productivity and prolonging the life of the cutting tool.

While the foregoing is directed to embodiments of the present disclosure, other and further embodiments of the present disclosure may be devised without departing from the basic scope thereof, and the scope thereof is determined by the claims that follow.

What is claimed is:

1. A computer-implemented method for selecting and configuring cutting tools based on simulated damage analysis, the method comprising:
identifying a cutting operation to be performed by a machining device on a workpiece;
identifying a plurality of cutting tools of the machining device that are suitable for performing the cutting operation;
simulating the cutting operation being performed with each of the plurality of cutting tools;
analyzing simulated damage to each of the plurality of cutting tools due to performance of the cutting operation;
selecting one of the plurality of cutting tools to perform the cutting operation based on the simulated damage to each of the plurality of cutting tools;
configuring the machining device to perform the cutting operation using the selected cutting tool; and
performing the cutting operation using the selected cutting tool.

2. The method of claim 1, wherein the simulating the cutting operation being performed with each of the plurality of cutting tools comprises using a trained artificial intelligence (AI) model.

3. The method of claim 2, wherein the AI model is trained using historical data on tool coating specifications, cutting parameters, machining outcomes, and real-time sensor inputs.

4. The method of claim 1, further comprising dynamically adjusting cutting parameters based on real-time assessments of the tool coating health during the cutting operation.

5. The method of claim 4, wherein the real-time assessments are performed using data collected from sensors monitoring parameters such as temperature, vibration levels, and a condition of the cutting tool and the workpiece.

6. The method of claim 5, wherein the sensors include high-resolution thermal cameras or advanced vibration sensors.

7. The method of claim 4, further comprising using specific algorithms for dynamically adjusting cutting parameters based on different types of wear detected on the tool coating.

8. The method of claim 1, further comprising activating secondary systems to provide additional support during the cutting operation.

9. A system comprising:
a memory comprising computer readable instructions; and
a processing device for executing the computer readable instructions, the computer readable instructions controlling the processing device to perform operations comprising:
identifying a cutting operation to be performed by a machining device on a workpiece;
identifying a plurality of cutting tools of the machining device that are suitable for performing the cutting operation;
simulating the cutting operation being performed with each of the plurality of cutting tools;
analyzing simulated damage to each of the plurality of cutting tools due to performance of the cutting operation;
selecting one of the plurality of cutting tools to perform the cutting operation based on the simulated damage to each of the plurality of cutting tools;
configuring the machining device to perform the cutting operation using the selected cutting tool; and
performing the cutting operation using the selected cutting tool.

10. The system of claim 9, wherein the simulating the cutting operation being performed with each of the plurality of cutting tools comprises using a trained artificial intelligence (AI) model.

11. The system of claim 10, wherein the AI model is trained using historical data on tool coating specifications, cutting parameters, machining outcomes, and real-time sensor inputs.

12. The system of claim 9, wherein the operations further comprise dynamically adjusting cutting parameters based on real-time assessments of the tool coating health during the cutting operation.

13. The system of claim 12, wherein the real-time assessments are performed using data collected from sensors monitoring parameters such as temperature, vibration levels, and a condition of the cutting tool and the workpiece.

14. The system of claim 13, wherein the sensors include high-resolution thermal cameras or advanced vibration sensors.

15. The system of claim 12, wherein the operations further comprise using specific algorithms for dynamically adjusting cutting parameters based on different types of wear detected on the tool coating.

16. The system of claim 10, wherein the operations further comprise activating secondary systems to provide additional support during the cutting operation.

17. A computer program product for selecting and configuring cutting tools based on simulated damage analysis, the computer program product comprising:
a set of one or more computer-readable storage media;
program instructions, collectively stored in the set of one or more storage media, for causing a processor set to perform the following computer operations:
identifying a cutting operation to be performed by a machining device on a workpiece;
identifying a plurality of cutting tools of the machining device that are suitable for performing the cutting operation;
simulating the cutting operation being performed with each of the plurality of cutting tools;
analyzing simulated damage to each of the plurality of cutting tools due to performance of the cutting operation;
selecting one of the plurality of cutting tools to perform the cutting operation based on the simulated damage to each of the plurality of cutting tools;
configuring the machining device to perform the cutting operation using the selected cutting tool; and
performing the cutting operation using the selected cutting tool.

18. The computer program product of claim 17, wherein the simulating the cutting operation being performed with each of the plurality of cutting tools comprises using a trained artificial intelligence (AI) model.

19. The computer program product of claim 18, wherein the AI model is trained using historical data on tool coating specifications, cutting parameters, machining outcomes, and real-time sensor inputs.

20. The computer program product of claim 17, wherein the operations further comprise dynamically adjusting cutting parameters based on real-time assessments of the tool coating health during the cutting operation.
